(19) United States
(12) Patent Application Publication
(10) Pub. No.: US 2007/0223185 A1
(43) Pub. Date: Sep. 27, 2007

(54) Flat panel display with pivot mechanism

(75) Inventors: Te-Hsu Wang, Miao-Li (TW); Ming-Chuan Li, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/728,544

(22) Filed: Mar. 26, 2007

(30) Foreign Application Priority Data
Mar. 24, 2006 (TW) 95110319

(51) Int. Cl. G06F 1/16

(52) U.S. Cl. 361/681

(57) ABSTRACT

An exemplary flat panel display (2) includes a display module (21), a supporting member (25), and a bolt (231). The display module includes a plurality of first connecting portions (211) provided at a back side thereof. The supporting member includes a plurality of second connecting portions (251). Each of the first and second connecting portions includes a pivot hole (213 and 253), the first and second connecting portions are interleavedly and interferingly connected with one another such that the pivot holes of the first and second connecting portions are aligned, and the bolt extends through the pivot holes, such that the display module is pivotable relative to the supporting member.

### FIELD OF THE INVENTION

The present invention relates to display devices, and more particularly to a flat panel display having a display module pivotally attached to a base.

### BACKGROUND

Display devices have been widely applied to various electronic equipment in which messages or pictures need to be displayed, such as notebook computers and personal computers. Because a typical display device has an optimal viewing angle, it is desirable that the display device can be inclined forward or backward to attain the optimal viewing angle for any particular user.

Referring to FIG. 3, a conventional flat panel display 1 includes a display module 11, a base 12, and a pivot mechanism 13.

The pivot mechanism 13 is rotatably mounted on the base 12 via a hinge 14. A rear housing (not labeled) of the display module 11 defines a plurality of mounting holes 112, and the pivot mechanism 13 defines a plurality of mounting holes 132 corresponding to the mounting holes 112. In assembly, the display module 11 is fastened to the pivot mechanism 13 by engaging screws 15 in the corresponding mounting holes 112 and 132. After assembly, the display module 11 may be turned relative to the base 12 via rotation of the hinge 14.

Typically, the pivot mechanism 13 is mainly made of iron or another metallic material, so that the pivot mechanism 13 has enough mechanical strength to support the weight of the display module 11. However, the metallic material needed for the pivot mechanism 13 is relatively costly. In addition, the process of attaching the pivot mechanism 13 to the display module 11 is unduly complicated.

Accordingly, what is needed is a flat panel display that can overcome the above-described deficiencies.

### SUMMARY

In one preferred embodiment, a flat panel display includes a display module, a supporting member, and a bolt. The display module includes a plurality of first connecting portions provided at a back side thereof. The supporting member includes a plurality of second connecting portions. Each of the first and second connecting portions includes a pivot hole, the first and second connecting portions are interleavedly and interferingly connected with one another such that the pivot holes of the first and second connecting portions are aligned, and the bolt extends through the pivot holes, such that the display module is pivotable relative to the supporting member.

Other novel features and advantages will become more apparent from the following detailed description when taken in conjunction with the accompanying drawings.

### BRIEF DESCRIPTION OF THE DRAWINGS

FIG. 1 is a perspective, back view of a flat panel display according to an exemplary embodiment of the present invention.

FIG. 2 is an exploded view of the flat panel display of FIG. 1.

FIG. 3 is an exploded, perspective, back view of a conventional flat panel display.

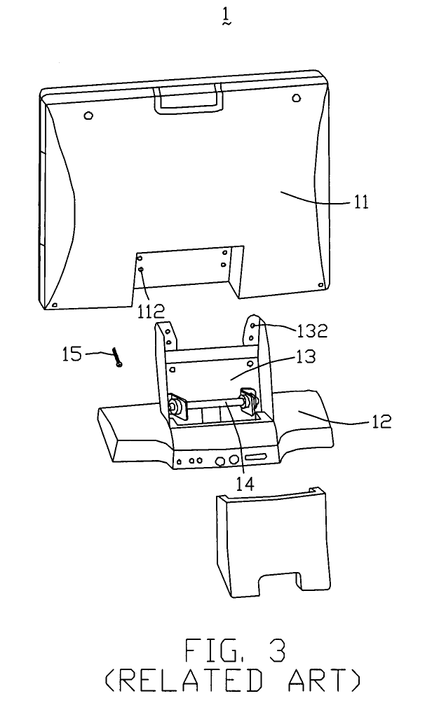

### DETAILED DESCRIPTION OF PREFERRED EMBODIMENTS

Reference will now be made to the drawings to describe preferred and exemplary embodiments of the present invention in detail.

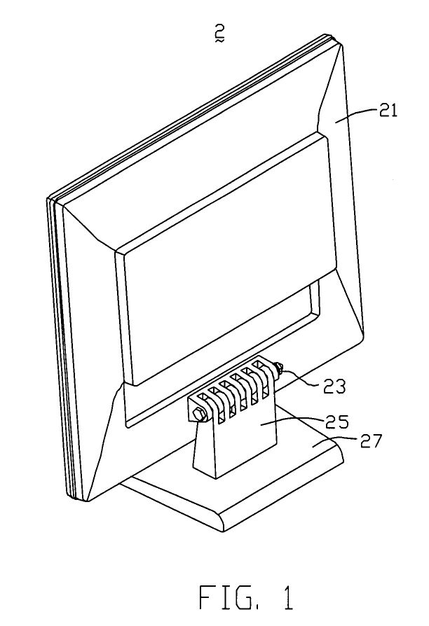

Referring to FIG. 1, a flat panel display 2 includes a display module 21, a pivot mechanism 23, a supporting bracket 25, and a base 27.

The display module 21 may for example be a liquid crystal display (LCD) module, a plasma display module, or a light emitting diode (LED) display module. The supporting bracket 25 is disposed on the base 27 for supporting the display module 21. The display module 21 is engaged with the supporting bracket 25 via the pivot mechanism 23, and is capable of rotating relative to the supporting bracket 25.

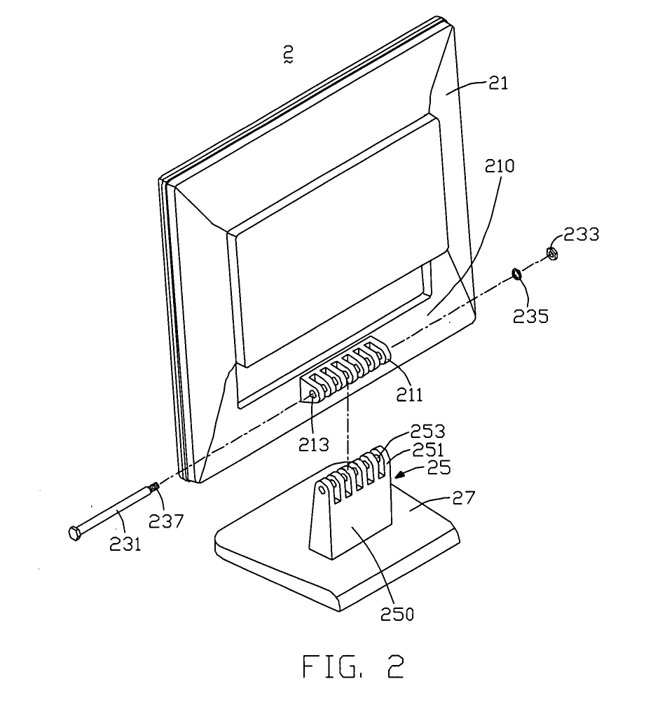

Also referring to FIG. 2, the plurality of first connecting portions 211 substantially perpendicularly extends from a back side of the display module 21. The first connecting portions 211 are arranged side by side parallel to each other, and are evenly spaced apart from one another. Further, in the illustrated embodiment, the first connecting portions 211 all integrally extend from a common base portion that is adjacent the back side of the display module 21. Thereby, the first connecting portions 211 and the base portion cooperatively form a toothed protrusion member. In the illustrated embodiment, the common base portion of the toothed protrusion member integrally extends from the back side of the display module 21. In particular, the common base portion of the toothed protrusion member integrally extends from the back side of a housing 210 of the display module 21. Each of the first connecting portions 211 has the same shape. A transverse width of each first connecting portion 211 as measured along an axis parallel to a top-to-bottom axis of the display module 21 gradually decreases along a direction from an end of the first connecting portion 211 nearest the back side of the display module 21 to a distal end of the first connecting portion 211 farthest away from the display module 21. Further, each first connecting portion 211 is generally arch-shaped, with a distal end portion of the first connecting portion 211 being curved. In the illustrated embodiment, the distal end portion of the first connecting portion 211 is arc-shaped. Each first connecting portion 211 includes a pivot hole 213 therein, and all the pivot holes 213 are aligned along an axis parallel to a side-to-side axis of the display module 21. That is, the pivot holes 213 are coaxial along a horizontal axis.

The supporting bracket 25 is disposed on the base 27. A top end of the supporting bracket 25 includes a plurality of second connecting portions 251, which integrally extend up from a main body 250 of the supporting bracket 25. The second connecting portions 251 are arranged side by side parallel to each other, and are evenly spaced apart from one another. Thereby, the second connecting portions 251 and a topmost portion of the main body 250 of the supporting bracket 25 cooperatively form a toothed protrusion member, which is similar to the toothed protrusion member having the first connecting portions 211. Each of the second connecting portions 251 has the same shape. A transverse width of each second connecting portion 251 as measured along a horizontal axis gradually decreases along a direction from an end of the second connecting portion 251 nearest the base 27 to a distal end of the second connecting portion 251 farthest away from the base 27. Further, each second connecting portion 251 is generally arch-shaped, with a distal end portion of the second connecting portion 251 being curved. In the illustrated embodiment, the distal end portion of the second connecting portion 251 is arc-shaped. Each second connecting portion 251 includes a pivot hole 253 therein, and all the pivot holes 253 are aligned along a horizontal axis. That is, the pivot holes 253 are coaxial along the horizontal axis.

In assembly of the flat panel display 2, firstly, the first connecting portions 211 of the display module 21 are interleavedly mated with the second connecting portions 251 of the supporting bracket 25. In particular, each second connecting portion 251 is interferingly received between two corresponding first connecting portions 211. Thereby, all the pivot holes 213 and 253 are aligned in a horizontal line to form a common through hole (not labeled). Thus, the display module 21 and the supporting bracket 25 are pre-assembled together. Secondly, a bolt 231 is extended through the common through hole formed by the pivot holes 213 and 253 to hingedly connect the display module 21 and the supporting bracket 25. One end of the bolt 231 protruding out from the common through hole has a screw thread thereon. An elastic washer 235 and a threaded nut 233 are engaged around and with the screw thread 237 respectively, with the elastic washer 235 sandwiched between an endmost one of the first connecting portions 211 and the threaded nut 233. Thereby, the display module 21 is pivotably fixed to the supporting bracket 25.

Once the flat panel display 2 is assembled, the first and second connecting portions 211, 251, the bolt 231, the elastic washer 235, and the threaded nut 233 cooperatively form the pivot mechanism 23. A user can manually adjust a tilt angle of the display module 21 relative to the base 27, with the first connecting portions 211 rotating relative to the second connecting portions 253 during such adjustment. Friction between the first and second connecting portions 211 and 251 of the pivot mechanism 23 is such that the user can rotate the display module 21 to a desired angle, and when the desired angle is reached the display module 21 simply stays secured in the desired position and does not move. The friction can be modulated via appropriately rotating the threaded nut 233 along the screw thread 237, and thereby further fastening the connecting portions 211 and 251 together or slightly releasing the connecting portions 211 and 251 from one another as desired.

Advantageously, the first and second connecting portions 211 and 251 are integrally formed with the display module 21 and the supporting bracket 25, respectively. Unlike in a conventional flat panel display, there is no separate pivot mechanism made of iron and requiring attachment to the display module. That is, the integrated connecting portions 211 and 251 provide the flat panel display 2 with a simple structure, relatively easy assembly, and reduced cost.

In further and/or alternative embodiments, each of the first connecting portions of the display module can be interferingly received between two corresponding second connecting portions of the supporting bracket. Moreover, the numbers of first and second connecting portions are not limited. For example, the numbers of first and second connecting portions can be selected according to the size of the display module.

It is to be further understood that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A flat panel display, comprising:
a display module with a plurality of first connecting portions provided at a back side thereof;
a supporting member with a plurality of second connecting portions; and
a bolt;
wherein each of the first and second connecting portions comprises a pivot hole, the first and second connecting portions are interleavedly and interferingly connected with one another such that the pivot holes of the first and second connecting portions are aligned, and the bolt extends through the pivot holes, such that the display module is pivotable relative to the supporting member.

2. The flat panel display as claimed in claim 1, wherein the first connecting portions are arranged parallel to each other and are evenly spaced apart from one another, and the first connecting portions have the same shape.

3. The flat panel display as claimed in claim 2, wherein a transverse width of each first connecting portion gradually decreases along a direction from an end of the first connecting portion at the back side of the display module to an end of the first connecting portion farthest from the display module, and an end part of each first connecting portion is curved.

4. The flat panel display as claimed in claim 3, wherein all the pivot holes of the first connecting portions are aligned along a horizontal axis.

5. The flat panel display as claimed in claim 1, further comprising a base, wherein the supporting member is disposed on the base, and the second connecting portions are provided at a distal end of the supporting member.

6. The flat panel display as claimed in claim 5, wherein the second connecting portions are arranged parallel to each other and are evenly spaced apart from one another, and the second connecting portions have the same shape.

7. The flat panel display as claimed in claim 6, wherein a transverse width of each second connecting portion gradually decreases along a direction from an end of the second connecting portion nearest the base to an end of the second connecting portion farthest from the base, and an end part of each second connecting portion is curved.

8. The flat panel display as claimed in claim 7, wherein all the pivot holes of the second connecting portions are aligned along a horizontal axis.

9. The flat panel display as claimed in claim 1, wherein each second connecting portion is received between two corresponding first connecting portions.

10. The flat panel display as claimed in claim 9, wherein the pivot holes of the first and second connecting portions cooperatively form a common through hole, and the bolt extends through the common through hole and hingedly connects the display module and the supporting member.

11. The flat panel display as claimed in claim 10, further comprising an elastic washer and a nut, wherein an end of the bolt protrudes out from the common through hole, the end of the bolt has a screw thread thereon, the elastic washer is located around the end of the bolt, and the nut is engaged with the screw thread.

12. The flat panel display as claimed in claim 11, wherein the elastic washer is sandwiched between an endmost one of the first connecting portions and the nut.

13. The flat panel display as claimed in claim 11, wherein the first and second connecting portions, the bolt, the elastic washer, and the nut cooperatively form a pivot mechanism.

14. A flat panel display, comprising:
a display module comprising a housing;
a supporting member having a main body; and
a pivot mechanism comprising a plurality of first connecting portions integrally extending from the housing of the display module, a plurality of second connecting portions integrally extending from the main body of the supporting member, and a bolt;
wherein each of the first and second connecting portions comprises a pivot hole therein, the first and second connecting portions are interleavedly and interferingly connected with one another with the bolt extending through the pivot holes of the first and second connecting portions and hingedly connecting the first and second connecting portions together, and the display module is thereby pivotable relative to the supporting member via the pivot mechanism.

15. The flat panel display as claimed in claim 14, wherein the first connecting portions are arranged parallel to each other and are evenly spaced apart from one another, and the first connecting portions have the same shape.

16. The flat panel display as claimed in claim 15, wherein all the pivot holes of the first connecting portions are aligned along a horizontal axis.

17. The flat panel display as claimed in claim 14, further comprising a base, wherein the supporting member is disposed on the base, and the second connecting portions are provided at a distal end of the supporting member.

18. The flat panel display as claimed in claim 17, wherein the second connecting portions are arranged parallel to each other and are evenly spaced apart from one another, and the second connecting portions have the same shape.

19. A flat panel display, comprising:
a display module with a plurality of first connecting portions provided at a back side thereof;
a supporting member with a plurality of second connecting portions, the supporting member configured for supporting the display module; and
a bolt extending through the first and second connecting portions and hingedly engaging the display module to the supporting member;
wherein the first and second connecting portions are interleavedly and interferingly connected with one another;
when force is applied by a user to the display module, the display module is pivoted to a desired tilt angle relative to the supporting member; and
when the force is removed, the display module remains in position at the desired tilt angle relative to the supporting member.

20. The flat panel display as claimed in claim 19, further comprising an elastic washer and a nut, wherein an end of the bolt protrudes out from an endmost one of the first and second connecting portions, the end of the bolt has a screw thread thereon, the elastic washer is located around the end of the bolt, and the nut is engaged with the screw thread.
